(19) United States
(12) Patent Application Publication
(10) Pub. No.: US 2014/0194268 A1
(43) Pub. Date: Jul. 10, 2014

(54) Fringed Decorative Bag Insert

(71) Applicants: Lynda B. Middlemas, Amelia Island, FL (US); Morgan Middlemas, Amelia Island, FL (US)

(72) Inventors: Lynda B. Middlemas, Amelia Island, FL (US); Morgan Middlemas, Amelia Island, FL (US)

(21) Appl. No.: 13/788,625

(22) Filed: Mar. 7, 2013

Related U.S. Application Data
(63) Continuation-in-part of application No. 29/441,409, filed on Jan. 4, 2013.

(51) Int. Cl. D04D 5/00; B31F 1/00; B31B 49/00; B31D 5/00

(52) U.S. Cl. CPC D04D 5/00; B31D 5/00; B31F 1/0003; B31B 49/00
USPC 493/394; 493/356; 428/115

(57) ABSTRACT

A decorative gift bag insert having multiple layers of folded decorative sheets, the bag insert having a self-standing base portion and an upper portion composed of fringe members. The bag insert is manufactured by overlapping a plurality of decorative sheets, horizontally folding a plurality of overlapping decorative sheets and cutting the fringe members on the non-folded edges opposite the folded edge, or alternatively cutting the fringe members on opposing edges of the overlapping decorative sheets, then vertically folding the plurality of decorative sheets to create the self-standing base portion suitable for insertion into an open-topped bag.

This application is a continuation-in-part of U.S. Design Patent Application Ser. No. 29/441,409, filed Jan. 4, 2013, the disclosure of which is incorporated herein by reference.

### BACKGROUND OF THE INVENTION

This invention relates generally to the broad field of package or container decoration, and more particularly relates to decoration of gift bags.

It is customary to present gifts in aesthetically pleasing or decorated containers. For example, gift boxes are typically wrapped in decorative tissue or wrapping paper with ribbons and bows affixed to the exterior. It is also well known to present gifts or the like in open-topped bags as well, and one method of decorating the gift bags is to insert asymmetrically folded, rectangular pieces of tissue paper, cellophane, foils, polymer films or other thin decorative sheets into the gift bag with a portion of the decorative paper extending above the top edge of the bag.

It is an object of this invention to provide a bag insert composed of tissue paper, cellophane, foils, polymer films or other thin decorative sheets that presents a more decorative appearance, the bag insert having a fringed upper portion to be disposed above the top edge of the bag.

### SUMMARY OF THE INVENTION

The invention is in general a fringed decorative gift bag insert, the bag insert being composed of one or more sheets or layers of folded decorative sheets, the term “decorative sheets” being used herein to encompass thin members composed of tissue paper, cellophane, foils, polymer films or the like, the relatively minimal thickness and composition of the decorative sheets being such that they are not self-supportive or self-standing when disposed vertically on edge. The decorative sheets comprising the bag insert are folded to create a self-supporting base portion of sufficient rigidity to maintain the bag insert in a generally vertical orientation when placed into an open-topped bag. The upper portion of the bag insert comprises a plurality of fringe members formed by slitting, stamping or otherwise cutting the upper portion of the bag insert. The fringe members, when the bag insert is placed in the bag, spread or fan out randomly to form an aesthetically pleasing display. The fringe members may be presented in a variety of shapes or patterns.

To produce the fringed decorative bag insert, one or more generally coextensive layers of thin decorative sheets are laid out, the decorative sheets being preferably rectangular. The opposing edges are then cut to produce the fringe members. Alternatively, the one or more layers of decorative sheets are first folded generally in half horizontally, and possibly folded vertically as well, and the non-folded edges opposite from the horizontal fold are then cut to produce the fringe members. If not already, the decorative sheets is then folded along vertical fold lines such that the base portion comprises a large number of overlapping layers with one or more vertical side folds, the combination of multiple layers and folded sides adding structural rigidity to the bag insert such that it becomes substantially self-supporting.

The bag insert may be positioned within the open top of a gift in a relatively tight configuration either along one bag wall or in the middle of the bag open top, or the bag insert may be spread open or unfolded to some degree such that the base portion is positioned against a portion of or the full perimeter of the interior walls of the bag. In addition, the bag insert could be affixed to the interior or exterior walls of the bag using adhesives, mechanical fasteners or the like.

Set forth in alternative terms, the invention is a decorative bag insert comprising a base portion comprising a portion of one or more decorative sheets folded to create a bottom fold composed of multiple layers of said decorative sheets and a plurality of side folds composed of multiple layers of said decorative sheets, said side folds adding structural rigidity to said base portion; and an upper portion comprising a plurality of fringe members formed from another portion of said one or more decorative sheets, whereby said base portion is self-supporting when inserted into an open-topped bag and whereby said fringe members are adapted to spread out randomly and extend from said bag; and further wherein said bottom fold is folded along a horizontal fold line and said side folds are folded along vertical fold lines, and further wherein said horizontal fold line is a midline of said decorative sheets.

The invention is also a method of manufacturing a decorative bag insert comprising the steps of combining a plurality of decorative sheets into a multi-layer assembly comprising opposing edges; cutting said opposing edges to create a plurality of fringe members; folding said multi-layer assembly horizontally along a horizontal fold line to create a bottom fold; and folding said multi-layer assembly vertically along vertical fold lines to create side folds, further wherein said horizontal fold line is positioned at the midline of said multi-layer assembly, and further wherein said step of folding said multi-layer assembly horizontally along a horizontal fold line to create a bottom fold is performed prior to said step of cutting said opposing edges to create a plurality of fringe members, or wherein said step of folding said multi-layer assembly horizontally along a horizontal fold line to create a bottom fold and said step of folding said multi-layer assembly vertically along vertical fold lines to create side folds are performed prior to said step of cutting said opposing edges to create a plurality of fringe members, or a decorative insert bag manufactured in any of these manners.

Still alternatively, a method of decorating an open-topped gift bag comprising the steps of providing a decorative bag insert comprising a base portion comprising a plurality of decorative sheets, a bottom fold composed of multiple layers of said decorative sheets, and a plurality of side folds composed of multiple layers of said decorative sheets; and an upper portion comprising a plurality of fringe members; positioning said base portion within said gift bag such that said fringe members extend from said gift bag, and further comprising the step of partially unfolding said bag insert prior to positioning said base portion within said gift bag.

### BRIEF DESCRIPTION OF THE DRAWINGS

FIG. 1 illustrates a plurality of decorative sheets layered coextensively, one set of corners being exposed to illustrate the multiple layers.

FIG. 2 illustrates the decorative sheets of FIG. 1 folded along the horizontal mid-line with the upper portion having been cut to produce the fringe members.

FIG. 3 illustrates the bag insert of FIG. 2, now folded along vertical fold lines to produce a self-supporting base portion.

FIG. 4 illustrates the bag insert positioned about the periphery of a gift bag such that the fringe members extend above the open top of the gift bag.

FIG. 5 illustrates the bag insert positioned along one interior wall of a gift bag.

FIG. 6 illustrates the decorative sheets cut prior to folding to produce the fringe members.

### DETAILED DESCRIPTION OF THE INVENTION

With reference to the drawings, the invention will now be described in detail with regard to various embodiments. The invention is in general a fringed decorative gift bag insert 10, the bag insert 10 being composed of one or more sheets or layers 11 of decorative sheet members, as shown in FIG. 1, the term “decorative sheets” being used herein to define in general and encompass thin, normally flat, members composed of tissue paper, cellophane, foils, polymer films or the like, the relatively minimal thickness and composition of the decorative sheets being such that they are not self-supportive or self-standing when disposed vertically on edge. The decorative sheets may all be a single color or of differing colors. It is most preferable that a plurality of decorative sheets 11 be assembled as shown, as this allows a large number of relatively thin decorative sheets 11 to be used. The decorative sheets 11 are preferably of identical dimensions, but a multi-layer assembly 15 may also be created with decorative sheets 11 of varying sizes or thicknesses, the multi-layer assembly 15 comprising a plurality of decorative sheets 11 initially layered one atop the other to form a stack.

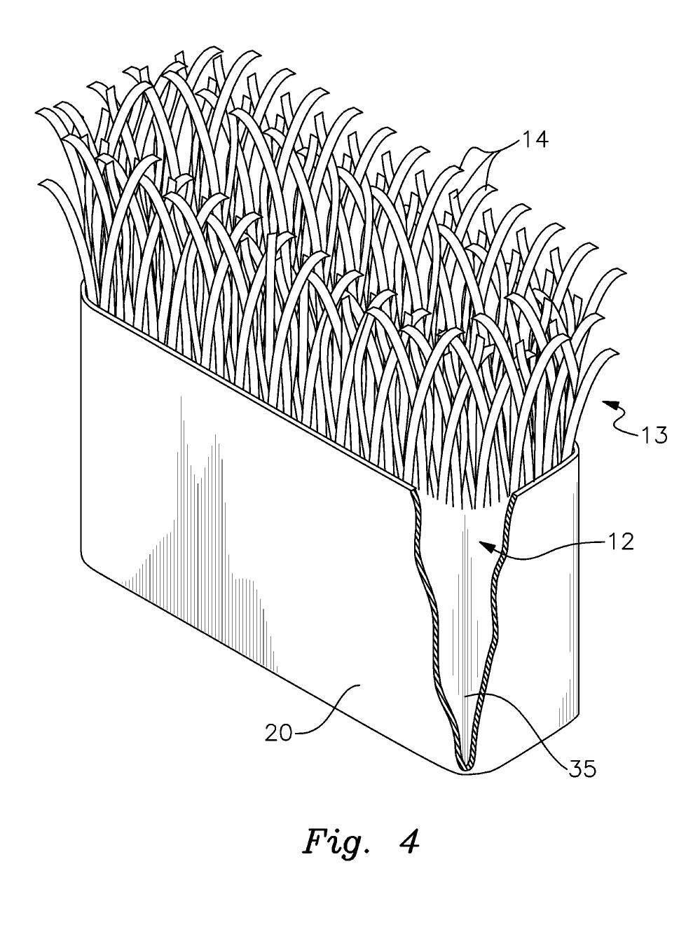

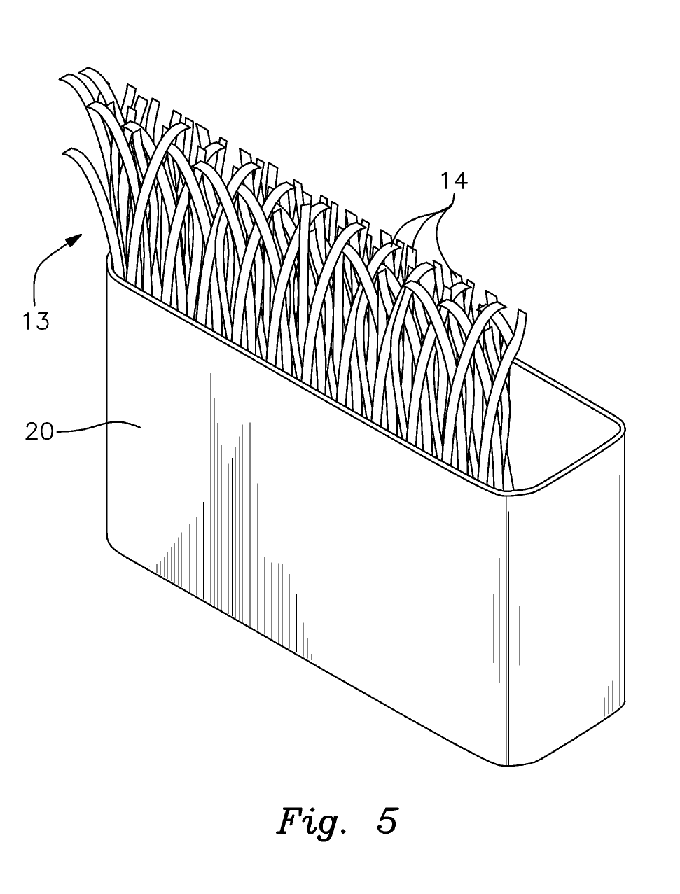

The multi-layer assembly 15 of decorative sheets 11 is folded to create a self-supporting base portion 12 of sufficient rigidity to maintain the bag insert 10 in a generally vertical orientation when placed into an open-topped bag 20, as shown in FIGS. 4 and 5. The presence of multiple decorative sheet layers 11 and the presence of vertical side folds 35 enables the bag insert 10 to remain upright. For example, a bag insert 10 composed of seven decorative sheets 11 and folded both horizontally and vertically as described below and shown in the drawings may have up to 84 co-planar layers when inserted into a gift bag 20.

The upper portion 13 of the bag insert 10 comprises a plurality of fringe members 14 formed by slitting, stamping or otherwise cutting the upper portion 13 of the bag insert 10. When the multi-layer assembly 15 is composed of equally sized decorative sheets 11 and the horizontal fold line 31 is at the midline between opposing edges, the fringe members 14 will be of the same length. If the horizontal fold line 31 is not at the midline, or if decorative sheets 11 of differing dimensions are used, the length of the fringe members 14 will vary. When the base portion 12 of the bag insert 10 is placed into the bag 20, the fringe members 14 spread or fan out randomly to form an aesthetically pleasing display. The fringe members 14 may be presented in a variety of shapes or patterns, such as for example linear ribbon-like members, leaves of grass, asymmetrical shapes, animal or character figures, etc.

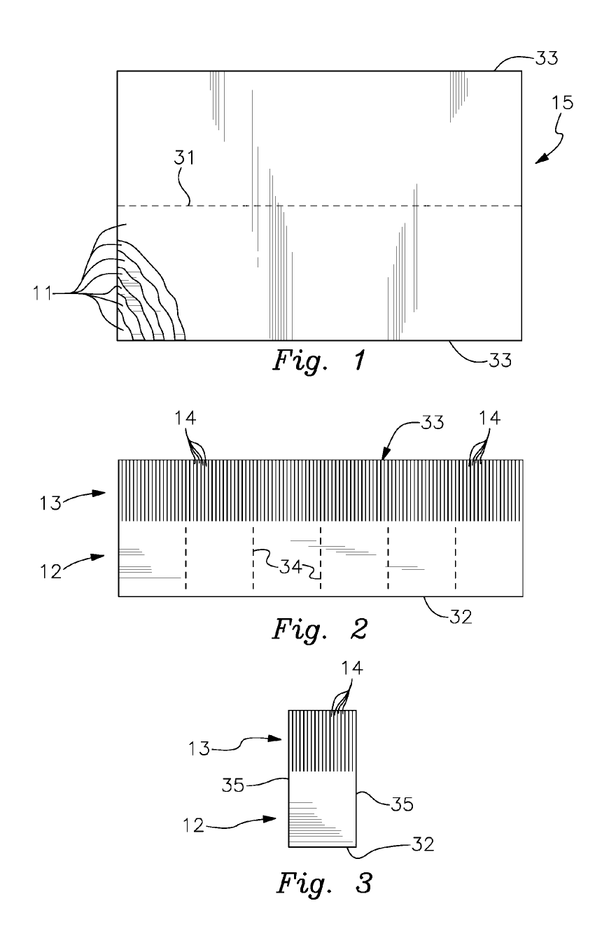

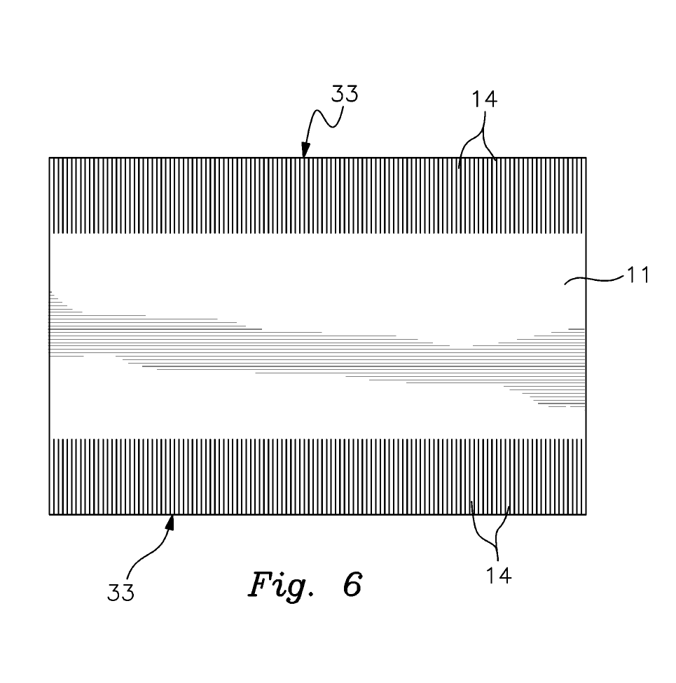

In one representative method to produce the fringed decorative bag insert 10, a plurality of generally coextensive layers 11 of decorative paper are laid out, as shown in FIG. 1. The opposing edges 33 may then be cut to produce the fringe members 14, as shown in FIG. 6, or alternatively the decorative sheets 11 are first folded in half along the horizontal fold line 31 to create a bottom fold 32 composed of multiple folded decorative sheets 11, and the non-folded opposing edges 33 opposite from the fold 32 are then cut to produce the fringe members 14, as shown in FIG. 2. Alternatively, the fringe members 14 of each decorative sheet 11 could be cut individually and then combined into the multi-layer assembly 15. In another alternative method, the decorative sheets 11 could be produced in extended roll form with the fringed members 14 cut prior to cutting the roll into individual decorative sheets 11.

The multi-layer assembly 15 is then folded multiple times along vertical fold lines 34 such that the base portion 12 comprises a large number of overlapping layers with one or more vertical side folds 35 composed of multiple folded tissue sheets 11, the combination of multiple decorative sheet layers 11 and folded sides 35 adding structural rigidity to the bag insert 10, as shown in FIG. 3. In another alternative method, the step of cutting the fringe members 14 could be cut after the vertical folding steps have been accomplished.

The bag insert 10 may simply be inserted into the open top of the gift bag 20, may be positioned within the open top of a gift bag 20 in a relatively tight configuration either along one bag wall, as shown in FIG. 5, or the bag insert 10 may be spread open or unfolded to some degree such that the base portion 12 is positioned against a portion of or the full perimeter of the walls of the bag 20, as shown in FIG. 4. In addition, the bag insert 10 could be affixed to the interior or exterior walls of the bag 20 using adhesives, mechanical fasteners or the like.

It is understood that equivalents and substitutions for certain elements and structures set forth above may be obvious to those of skill in the art, and therefore the true scope and definition of the invention is to be as set forth in the following claims.

We claim:

1. A decorative bag insert comprising:
a base portion comprising a lower portion of one or more decorative sheets folded to create a bottom fold composed of multiple layers of said decorative sheets and a plurality of side folds composed of multiple layers of said decorative sheets, said side folds adding structural rigidity to said base portion; and
an upper portion comprising a plurality of fringe members formed from an upper portion of said one or more decorative sheets,
whereby said base portion is self-supporting when inserted into an open-topped bag and whereby said fringe members are adapted to spread out randomly and extend from said bag.

2. The bag insert of claim 1, wherein said bottom fold is folded along a horizontal fold line and said side folds are folded along vertical fold lines.

3. The bag insert of claim 2, wherein said horizontal fold line is a midline of said decorative sheets.

4. A method of manufacturing a decorative bag insert comprising the steps of:
combining a plurality of decorative sheets into a multi-layer assembly comprising opposing edges;
cutting said opposing edges to create a plurality of fringe members;
folding said multi-layer assembly horizontally along a horizontal fold line to create a bottom fold; and
folding said multi-layer assembly vertically along vertical fold lines to create side folds.

5. The method of claim 4, wherein said horizontal fold line is positioned at the midline of said multi-layer assembly.

6. The method of claim 4, wherein said step of folding said multi-layer assembly horizontally along a horizontal fold line to create a bottom fold is performed prior to said step of cutting said opposing edges to create a plurality of fringe members.

7. The method of claim 4, wherein said step of folding said multi-layer assembly horizontally along a horizontal fold line to create a bottom fold and said step of folding said multi-layer assembly vertically along vertical fold lines to create side folds are performed prior to said step of cutting said opposing edges to create a plurality of fringe members.

8. A decorative bag insert manufactured by the method of claim 4.

9. A decorative bag insert manufactured by the method of claim 5.

10. A decorative bag insert manufactured by the method of claim 6.

11. A decorative bag insert manufactured by the method of claim 7.

12. A method of decorating an open-topped gift bag comprising the steps of:
providing a decorative bag insert comprising a base portion comprising a plurality of decorative sheets, a bottom fold composed of multiple layers of said decorative sheets, and a plurality of side folds composed of multiple layers of said decorative sheets; and an upper portion comprising a plurality of fringe members;
positioning said base portion within said gift bag such that said fringe members extend from said gift bag.

13. The method of claim 12, further comprising the step of partially unfolding said bag insert prior to positioning said base portion within said gift bag.
